(19) United States
(12) Patent Application Publication
(10) Pub. No.: US 2024/0300559 A1
(43) Pub. Date: Sep. 12, 2024

(54) ANTI-PINCH FOLDABLE TROLLEY

(71) Applicants: YONGKANG RUNHENG MACHINERY CO., LTD, Zhejiang (CN); Zhejiang Beihuan Outdoor Products Co., Ltd, Zhejiang Province (CN)

(72) Inventors: Yongshuai ZHOU, Zhejiang Province (CN); Guosen ZOU, Zhejiang Province (CN)

(21) Appl. No.: 18/598,279

(22) Filed: Mar. 7, 2024

(30) Foreign Application Priority Data
Mar. 9, 2023 (CN) 202320436204.4

(51) Int. Cl. B62B 3/00; B62B 3/02; B62B 5/06

(52) U.S. Cl. CPC B62B 3/007; B62B 3/025; B62B 5/067; B62B 2205/06

(57) ABSTRACT

The present disclosure provides an anti-pinch foldable trolley, including four side frames, a bottom frame, wheels and four supporting columns. The four side frames and the bottom frame are all arranged on the four supporting columns and define a frame with an opening in an upper end; the wheels are arranged at four corners of the bottom frame; at least two opposite side frames are provided with one or more X-shaped folding frames; each X-shaped folding frame includes a rotating piece, and four connecting rods fixedly connected to the rotating piece; each rotating piece includes two hinged bases hinged to each other; two ends of each hinged base are provided with inserting connectors used for being connected to the corresponding connecting rods; and the inserting connectors at the two ends of at least one hinged base are arranged in a staggered mode.

### RELATED APPLICATIONS

This application claims the benefit of Chinese Patent Application No. 202320436204.4, filed Mar. 9, 2023, the entire disclosures of which are hereby incorporated herein by reference.

### TECHNICAL FIELD

The present disclosure relates to the field of trolleys, and in particular to an anti-pinch foldable trolley.

### BACKGROUND ART

A foldable trolley is a tool used for transporting items or luggage for short distances, with good load-bearing performance and small storage size after being folded. More and more people use the foldable trolley for carrying items or carrying out outdoor activities.

For example, a publication No. CN202806813U discloses a bundling type luggage trolley. The bundling type luggage trolley includes a frame, a handlebar arranged in front of the frame, and wheels fixed to a bottom of the frame; and the frame includes a bottom frame, a front frame, a rear frame, and side frames arranged on two side faces of the bottom frame. Each side frame is of a symmetrical structure including at least two sets of X assemblies arranged side by side and a plurality of hinged joints connected to the X assemblies; each X assembly includes a first oblique beam and a second oblique beam which are hinged through a hinged shaft arranged in a middle of the X assembly; one end of each first oblique beam and one end of each second oblique beam are hinged to the corresponding first oblique beam or the corresponding second oblique beam in the other X assembly through the hinged joints; and the other end of each first oblique beam and the other end of each second oblique beam are hinged to the front frame or the rear frame or the corresponding first oblique beam or the corresponding second oblique beam in the other X assembly through the hinged joints.

For another example, a publication No. CN110001722A discloses a foldable trolley. The foldable trolley includes a pull rod assembly, a front support, a rear support, a bottom frame folding assembly, side frame folding assemblies and roller sets; one end of the bottom frame folding assembly is hinged to a bottom of the front support, and the other end thereof is hinged to a bottom of the rear support; the side frame folding assemblies are connected to two sides of the front support and two sides of the rear support; the roller sets are connected to the bottom of the front support and the bottom of the rear support respectively; the pull rod assembly is connected to the front support; the trolley is in a plate shape in a folded state and is in a cuboid shape in an unfolded state; and by arranging the bottom frame folding assembly and the side frame folding assemblies, the trolley may be contracted front and back so as to be folded.

The above two folding modes are also the most common foldable trolley folding modes in the market at present. One is bundling type storage, which realizes small storage size, but bearing capacity is slightly low. The other is plate type storage, which causes large storage size, but bearing capacity is high. The above two folding modes all utilize an X-shaped structure similar to scissors for folding, but when the structure in this mode is stored and unfolded, the X-shaped structure similar to the scissors will realize a shearing effect of the scissors, especially at the hinge of two connecting rods of the X-shaped structure, it is easy to pinch the hand or damage the item; and moreover, this structure is looser, and easy to shake in the unfolded state, and it is not even smooth after being folded, which affects the use experience and folding effect.

### SUMMARY OF THE INVENTION

### (I) Technical Problem to be Solved

The present disclosure provides an anti-pinch foldable trolley, aiming to overcome the defect that an existing foldable trolley is prone to bag sticking and hand pinching.

### (II) Technical Solution

In order to solve the technical problem, the present disclosure provides an anti-pinch foldable trolley. The anti-pinch foldable trolley includes four side frames, a bottom frame, wheels and four supporting columns; the four side frames and the bottom frame are all arranged on the four supporting columns and define a frame with an opening in an upper end; the wheels are arranged at four corners of the bottom frame; at least two opposite side frames are provided with one or more X-shaped folding frames; each X-shaped folding frame includes a rotating piece, and four connecting rods fixedly connected to the rotating piece; each rotating piece includes two hinged bases hinged to each other; two ends of each hinged base are provided with inserting connectors used for being connected to the corresponding connecting rods; and the inserting connectors at the two ends of at least one hinged base are arranged in a staggered mode.

Further, the inserting connectors at the two ends of each hinged base are arranged in a staggered mode; two inserting connectors located on the different hinged bases are arranged in a crossed mode; and four inserting connectors are located in a same plane. The hinged bases are circular; two inserting connectors are arranged on circular outer walls of the hinged bases in parallel in a staggered mode; the two circular hinged bases are hinged in a sleeved mode to form the rotating piece; and during storing, the four connecting rods are in an H shape through the two hinged bases.

Further, the two hinged bases are a hinged base A and a hinged base B respectively and are both in a hollow circular shape; an annular shaft part is arranged in the hinged base A; the hinged base B is rotationally mounted on the annular shaft part; and the hinged base A is provided with a rotating space for facilitating rotation of the hinged base B in a circumferential direction of the annular shaft part.

Further, the hinged base A includes a first shell and a second shell connected to each other in a clamped mode, and the hinged base B is rotationally mounted between the first shell and the second shell.

Further, any one of the two inserting connectors located on a same side is provided with a first stop part, and the other one is provided with a second stop part; and after unfolding, the first stop part and the second stop part abut against each other for limiting.

Further, every two adjacent X-shaped folding frames are hinged through a connecting structure; the connecting structure is formed by hinging two hinged joints, and each hinged joint is provided with a bent part; and in a storage state, hinge points of the hinged joints are located on outer sides of the X-shaped folding frames.

Further, the bottom frame includes a center base and four bottom rods; one end of each bottom rod is hinged to the center base, and the other end of each bottom rod is hinged to the corresponding supporting column; and during storing, the center base is lifted upwards, and the four bottom rods drive the four supporting columns to be folded towards the middle and drive the X-shaped folding frames to be folded. Each bottom rod includes a telescopic rod A and a telescopic rod B slidably connected to each other in a sleeved mode; a linkage rod is hinged to the center base, and the linkage rod is hinged to the telescopic rod A; and during storing, the center base is lifted upwards, the linkage rod compresses the telescopic rod A and the telescopic rod B to reduce a height of the center base after folding.

Further, the bottom frame further includes supporting rods; one end of each supporting rod is hinged to the center base, and the other end of each supporting rod is connected to a lower end of a center of the corresponding side frame through a connecting rope to disperse a supporting force of the bottom frame.

Further, a handle assembly is arranged at one end of the frame; the handle assembly includes a handle base, handle connecting rods hinged to the handle base, and a handle connected to the handle base in a sleeved mode; and ends of the handle connecting rods are hinged to the corresponding supporting columns.

Further, an upper end of one side of each X-shaped folding frame is hinged to the corresponding supporting column, and a lower end of one side of each X-shaped folding frame is slidably hinged to the corresponding supporting column.

### (III) Beneficial Effects

According to the present disclosure, compared with the prior art, the anti-pinch foldable trolley has the following advantages:
1) an existing X-shaped structure is redesigned; the rotating pieces and the four connecting rod structures are adopted; with the supporting of the two hinged bases, the four connecting rods can be stored in an H-shaped state through the rotating pieces during storing; the four connecting rods are in a parallel state, and a gap is formed between the connecting rods on the two sides, so the connecting rods are prevented from abutting or intersecting, shearing force cannot be generated during folding, bag sticking or hand pinching is prevented, and using safety is improved;
2) a bottom frame structure is formed by the telescopic bottom rods; during storing, the center base is lifted upwards, the linkage rod compresses telescopic rod A and the telescopic rod B to reduce the height of the center base after folding, and to greatly reduce the size after folding; the upper end of one side of each X-shaped folding frame is hinged to the corresponding supporting column, and the lower end of one side of each X-shaped folding frame is slidably hinged to the corresponding supporting column; the lower end of one side of each X-shaped folding frame slides downwards along the corresponding supporting column during folding, thus the height cannot be increased after folding, and the size is smaller after storage; and
3) the bottom frame structure is further provided with the supporting rods; one end of each supporting rod is connected to the lower end of the center of the corresponding side frame through the connecting rope, thus the supporting force of the bottom frame can be dispersed, the supporting strength is improved, and the structure is more stable.

### BRIEF DESCRIPTION OF THE DRAWINGS

FIG. 1 is a three-dimensional diagram of an anti-pinch foldable trolley according to the present disclosure;

FIG. 2 is a three-dimensional diagram of a bottom view angle of an anti-pinch foldable trolley according to the present disclosure;

FIG. 3 is a schematic structural diagram of a main view angle of an anti-pinch foldable trolley according to the present disclosure;

FIG. 4 is a three-dimensional diagram of a connecting structure of an anti-pinch foldable trolley according to the present disclosure;

FIG. 5 is a schematic structural diagram of an upward view angle of an anti-pinch foldable trolley according to the present disclosure;

FIG. 6 is a three-dimensional diagram of a bottom frame of an anti-pinch foldable trolley according to the present disclosure;

FIG. 7 is a schematic structural diagram of a side view angle of an anti-pinch foldable trolley according to the present disclosure;

FIG. 8 is a three-dimensional diagram of an X-shaped folding frame of an anti-pinch foldable trolley according to the present disclosure;

FIG. 9 is an exploded diagram of an X-shaped folding frame of an anti-pinch foldable trolley according to the present disclosure;

FIG. 10 is a three-dimensional diagram of a rotating piece of an anti-pinch foldable trolley according to the present disclosure;

FIG. 11 is an exploded diagram of a rotating piece of an anti-pinch foldable trolley according to the present disclosure;

FIG. 12 is a three-dimensional diagram of a hinged base B of an anti-pinch foldable trolley according to the present disclosure;

FIG. 13 is a three-dimensional diagram of a hinged base A of an anti-pinch foldable trolley according to the present disclosure;

FIG. 14 is a three-dimensional diagram of another view angle of a hinged base A of an anti-pinch foldable trolley according to the present disclosure; and

FIG. 15 is a schematic structural diagram of a rotating piece of an anti-pinch foldable trolley in a storage state according to the present disclosure;

Names of parts corresponding to marks in each figure: 1, bottom frame; 11, center base; 12, bottom rod; 13, linkage rod; 14, supporting rod; 15, connecting rope; 121, telescopic rod A; 122, telescopic rod B; 2, wheel; 3, supporting column; 4, X-shaped folding frame; 41, rotating piece; 42, connecting rod; 43, inserting connector; 411, hinged base A; 412, hinged base B; 413, annular shaft part; 414, first shell; 415, second shell; 416, first stop part; 417, second stop part; 5, connecting structure; 51, hinged joint; 6, handle assembly; 61, handle base; 62, handle connecting rod; and 63, handle.

### DETAILED DESCRIPTION OF THE INVENTION

The specific implementations of the present disclosure are further described in detail in combination with the accompanying drawings and embodiments. The following embodiments are used for illustrating the present disclosure, but are not intended to limit the scope of the present disclosure.

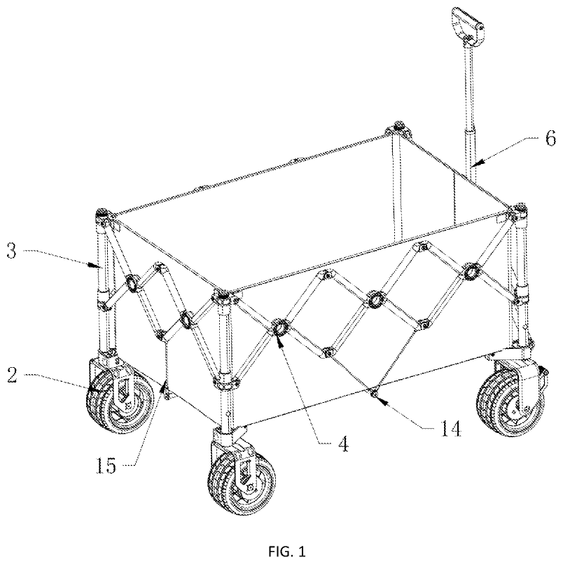

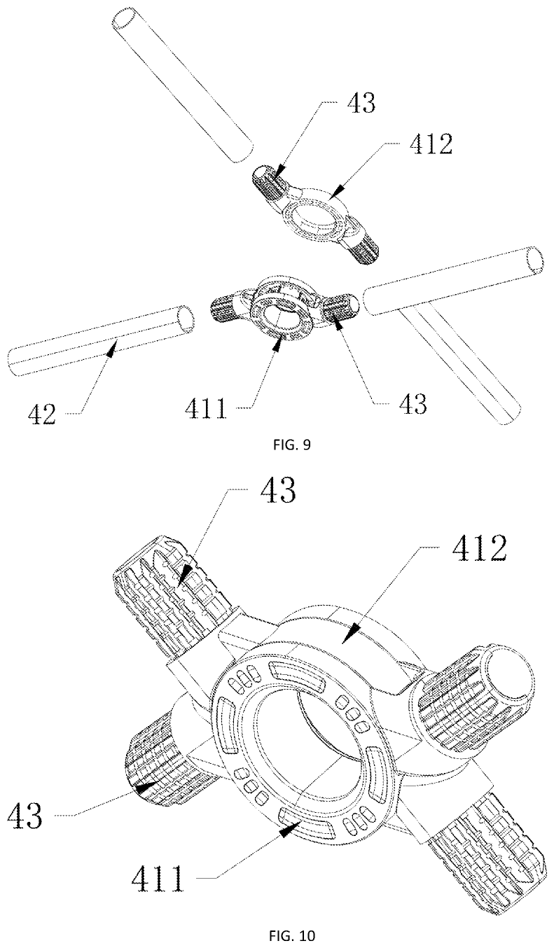

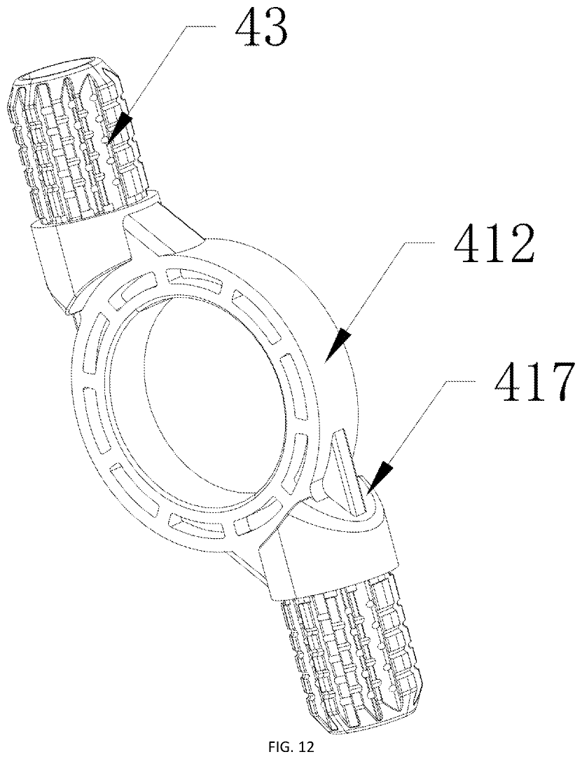

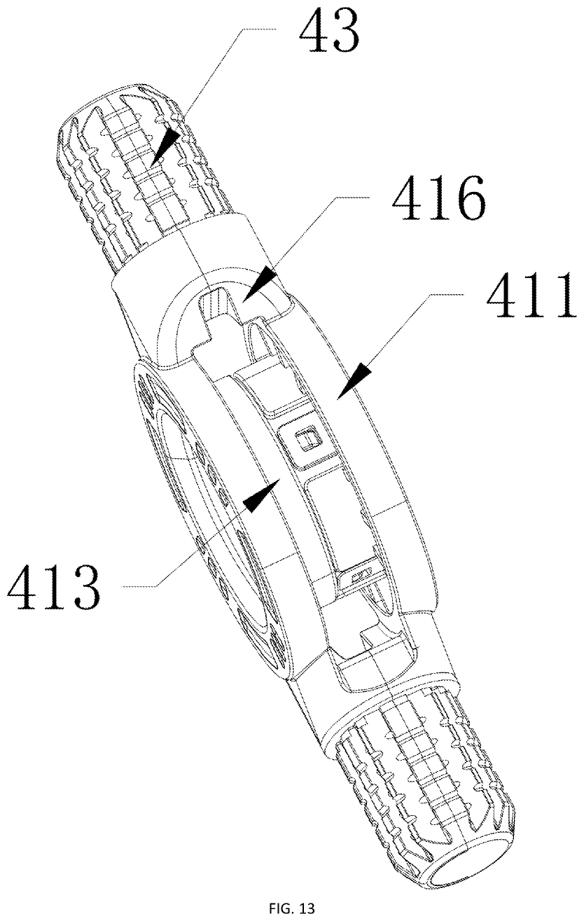

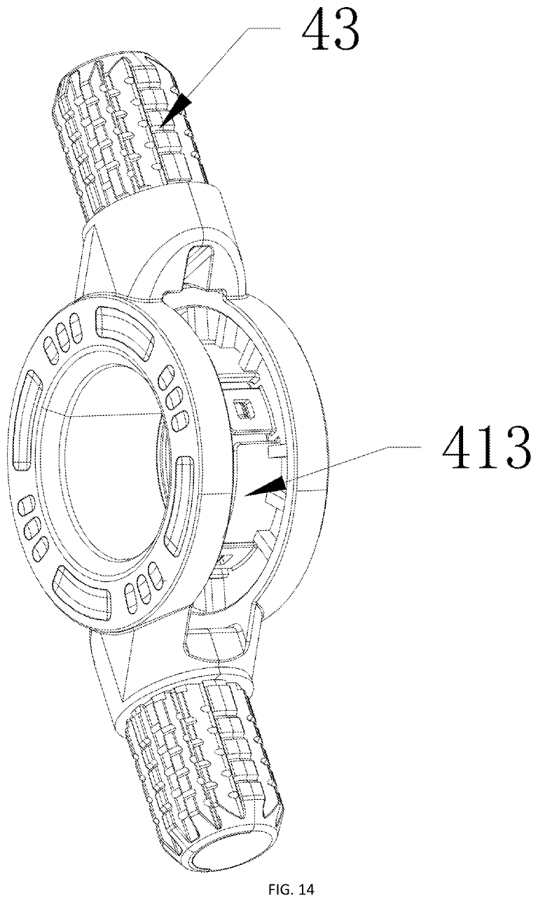

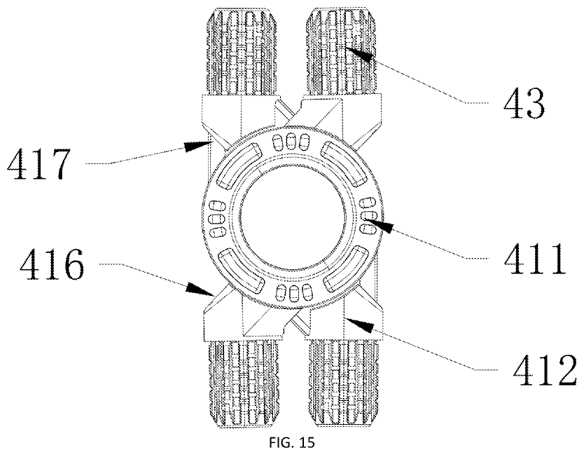

As shown in FIG. 1 to FIG. 15, the present disclosure provides an anti-pinch foldable trolley. The anti-pinch foldable trolley includes four side frames, a bottom frame 1, wheels 2 and four supporting columns 3. The four supporting columns 3 are vertically arranged in parallel and distributed in a rectangular shape. The four side frames and the bottom frame 1 are all arranged on the four supporting columns 3 and define a frame with an opening in an upper end, and the wheels 2 are arranged at four corners of the bottom frame 1. At least two opposite side frames are provided with one or more X-shaped folding frames 4 In order to guarantee the size of stored items, two side frames according to the present disclosure are connected through two X-shaped folding frames 4, and the other two side frames are connected through three X-shaped folding frames 4.

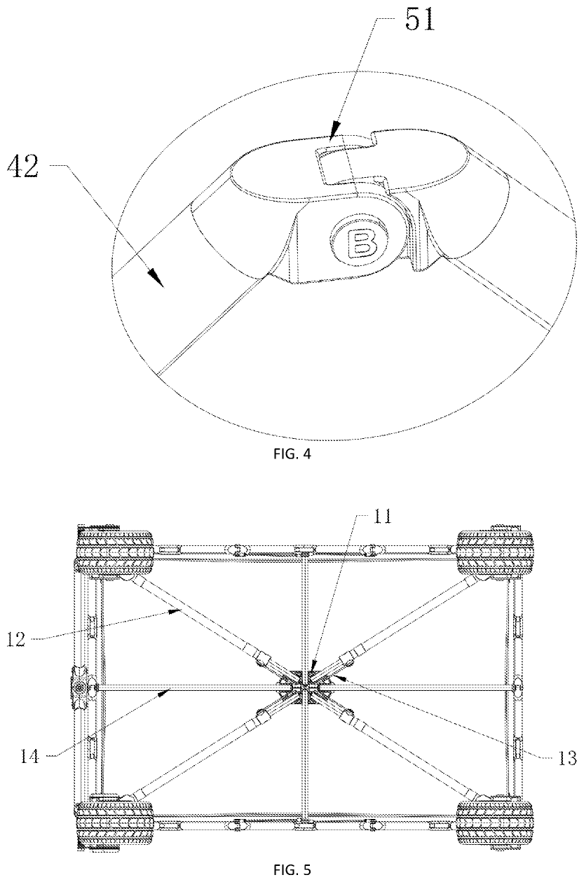

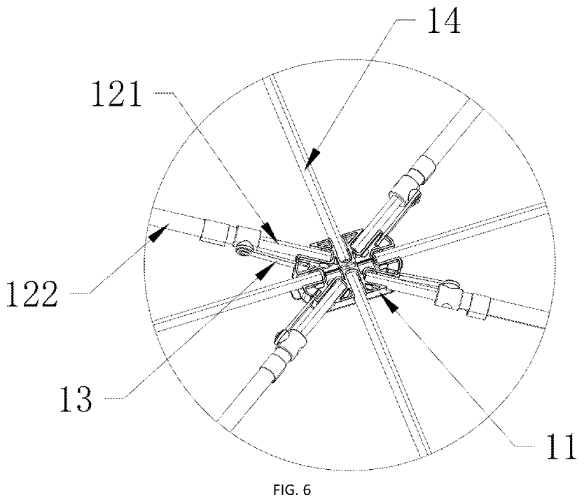

As shown in FIG. 3 and FIG. 4, every two adjacent X-shaped folding frames 4 are hinged through a connecting structure 5; the connecting structure 5 is formed by hinging two hinged joints 51; one of the two hinged joints 51 is in a U shape, and the other one is in a protruded shape; and the protruded hinged joint 51 is arranged in the U-shaped hinged joint 51 and then hinged through a hinged shaft. The hinged joints 51 are provided with bent parts, so that the hinged joints 51 can be in a horizontal state. In a storage state, hinge points of the hinged joints 51 are located on outer sides of the X-shaped folding frames 4.

As shown in FIG. 1 and FIG. 3, an upper end of one side of the X-shaped folding frame 4 located at the end is hinged to the corresponding supporting column 3, and a lower end of one side of the X-shaped folding frame located at the end is slidably hinged to the corresponding supporting column 3, that is, a sliding base is slidably mounted on the corresponding supporting column 3, and the lower end of the X-shaped folding frame 4 is hinged to the sliding base, and therefore, the X-shaped folding frame 4 can slide and rotate relative to the corresponding supporting column 3. By means of this structure, the lower end of one side of the X-shaped folding frame slides downwards along the corresponding supporting column during folding, so that the height after folding cannot be increased, and the storage size is smaller.

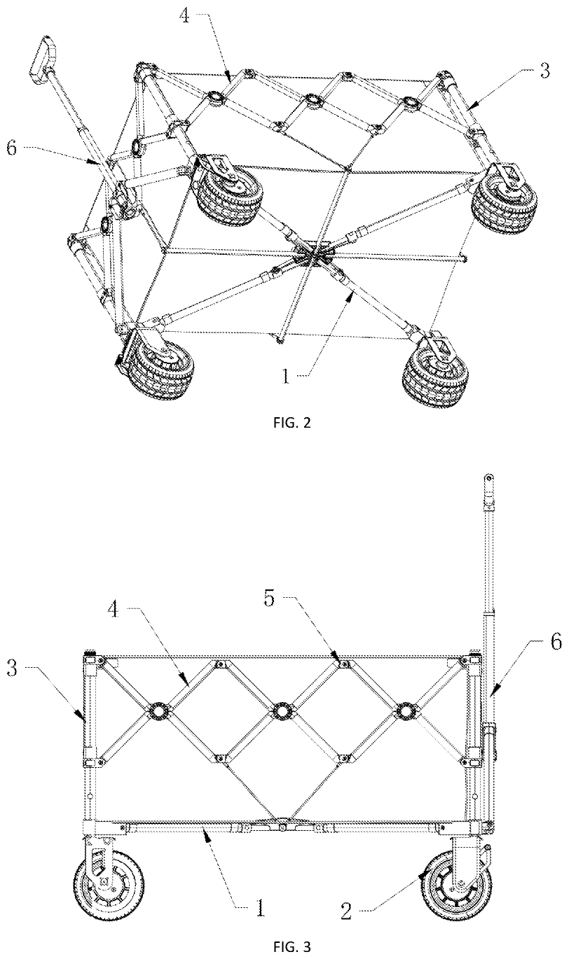

As shown in FIG. 2, FIG. 5 and FIG. 6, the bottom frame 1 includes a center base 11 located in the center, and four bottom rods 12. One end of each bottom rod is hinged to the center base 11, and the other end of each bottom rod 12 is hinged to the corresponding supporting column 3. During storing, the center base 11 is lifted upwards, the four bottom rods 12 drive the four supporting columns 3 to be folded towards the middle and drive X-shaped folding frames 4 to be folded. Each bottom rod 12 includes a telescopic rod A121 and a telescopic rod B122 slidably connected to each other in a sleeved mode, a linkage rod 13 is hinged to the center base 11, and the linkage rod 13 is hinged to the telescopic rod A121. During storing, the center base 11 is lifted upwards, the linkage rod 13 compresses the telescopic rod A121 and the telescopic rod B122 to reduce a height of the center base 11 after folding, and ensure that the storage size is smaller.

As shown in FIG. 2, FIG. 5 and FIG. 6, the bottom frame 1 further includes four supporting rods 14, and the four supporting rods 14 are vertically arranged. One end of each supporting rod 14 is hinged to the center base 11, and the other end of each supporting rod 14 is connected to a lower end of a center of the corresponding side frame through a connecting rope 15, to disperse a supporting force of the bottom frame 1, and make the structure more stable.

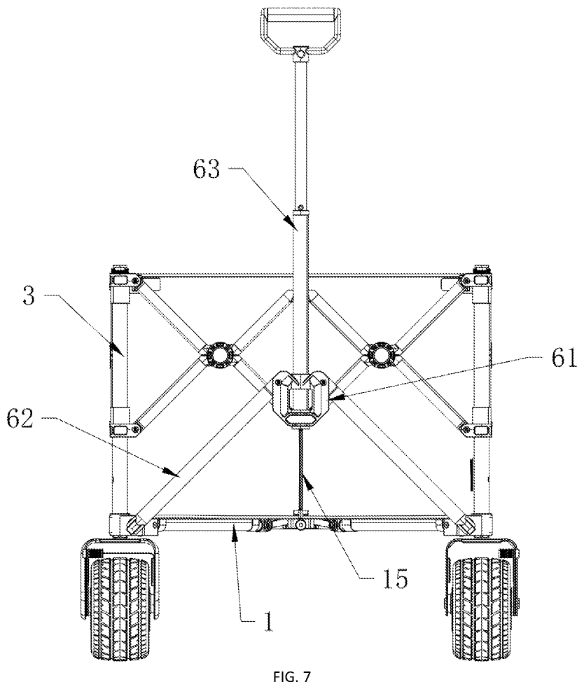

As shown in FIG. 2 and FIG. 7, a handle assembly 6 is arranged at one end of the frame; the handle assembly 6 includes a handle base 61, handle connecting rods 62 symmetrically hinged to the two sides of the handle base 61, and a handle 63 connected to the handle base 61 in a sleeved mode; and ends of the handle connecting rods 62 are hinged to the corresponding supporting columns 3.

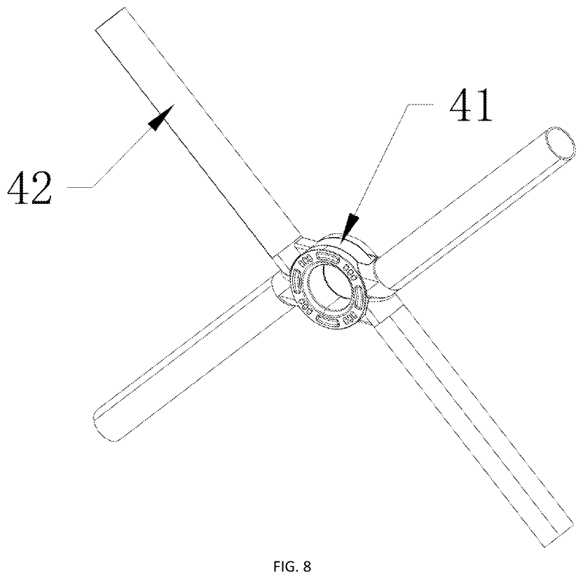

As shown in FIG. 8 to FIG. 10, each X-shaped folding frame 4 includes a rotating piece 41, and four connecting rods 42 fixedly connected to the rotating piece 41. Each rotating piece 41 includes two hinged bases hinged to each other. Two ends of each hinged base are provided with inserting connectors 43 used for being connected to the connecting rods 42. The inserting connectors 43 at the two ends of at least one hinged base are arranged in a staggered mode.

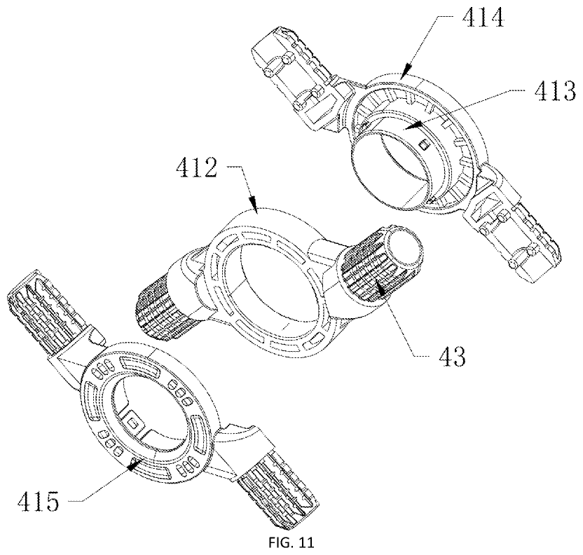

As shown in FIG. 11 to FIG. 14, in this embodiment, the inserting connectors 43 at the two ends of each hinged base are arranged in a staggered mode. The two inserting connectors 43 located on the different hinged bases are arranged in a crossed mode. Four inserting connectors 43 are located in a same plane. As shown in FIG. 10, any one of two inserting connectors 43 located on a same side (the left side or the right side) is provided with a first stop part 416, and the other one is provided with a second stop part 417. After unfolding, the first stop part 416 and the second stop part 417 abut against each other for limiting, so that the four connecting rods are in an X shape.

As shown in FIG. 10 to FIG. 15, the hinged bases are circular; the two inserting connectors 43 are arranged on circular outer walls of the hinged bases in parallel in a staggered mode. The two circular hinged bases are hinged in a sleeve mode to form the rotating pieces 41. During storing, the four connecting rods 42 are in an H shape through the two hinged bases. An existing X-shaped structure is redesigned; the rotating pieces and the four connecting rod structures are adopted; with the supporting of the two hinged bases, the four connecting rods can be stored in an H-shaped state through the rotating pieces during storing; the four connecting rods are in a parallel state, and a gap is formed between the connecting rods on the two sides, so the connecting rods are prevented from abutting or intersecting, shearing force cannot be generated during folding, bag sticking or hand pinching is prevented, and using safety is improved.

As shown in FIG. 1 to FIG. 15, the two hinged seats are a hinged seat A 411 and a hinged seat B 412 respectively and are both in a hollow circular shape. An annular shaft part 413 is arranged in the hinged seat A 411. The hinged seat B 412 is rotationally mounted on the annular shaft part 413. The hinged seat A 411 is provided with a rotating space for facilitating rotation of the hinged seat B 412 in a circumferential direction of the annular shaft part 413.

As shown in FIG. 11 to FIG. 13, the hinged seat A 411 includes a first shell 414 and a second shell 415 connected to each other in a clamped mode, and the hinged seat B 412 is rotationally mounted between the first shell 414 and the second shell 415.

According to the anti-pinch foldable trolley provided by the present disclosure, an existing X-shaped structure is redesigned; the rotating pieces and the four connecting rod structures are adopted; with the supporting of the two hinged bases, the four connecting rods can be stored in an H-shaped state through the rotating pieces during storing; the four connecting rods are in a parallel state, and a gap is formed between the connecting rods on the two sides, so the connecting rods are prevented from abutting or intersecting, shearing force cannot be generated during folding, bag sticking or hand pinching is prevented, and using safety is improved. A bottom frame structure is formed by the telescopic bottom rods; during storing, the center base is lifted upwards, the linkage rod compresses telescopic rod A and the telescopic rod B to reduce the height of the center base after folding, and to greatly reduce the size after folding; the upper end of one side of each X-shaped folding frame is hinged to the corresponding supporting column, and the lower end of one side of each X-shaped folding frame is slidably hinged to the corresponding supporting column; the lower end of one side of each X-shaped folding frame slides downwards along the corresponding supporting column during folding, thus the height cannot be increased after folding, and the size is smaller after storage; and the bottom frame structure is further provided with the supporting rods; one end of each supporting rod is connected to the lower end of the center of the corresponding side frame through the connecting rope, thus the supporting force of the bottom frame can be dispersed, the supporting strength is improved, and the structure is more stable.

The above is only the preferred implementation of the present disclosure. It is to be pointed out that for those of ordinary skill in the art, on the premise of not separating from the technical principle of the present disclosure, a number of improvements and refinements may be made, and these improvements and refinements should also be regarded as the scope of protection of the present disclosure.

1. An anti-pinch foldable trolley, comprising four side frames, a bottom frame (1), wheels (2) and four supporting columns (3) wherein the four side frames and the bottom frame (1) are all arranged on the four supporting columns (3) and define a frame with an opening in an upper end; the wheels (2) are arranged at four corners of the bottom frame (1); at least two opposite side frames are provided with one or more X-shaped folding frames (4); each X-shaped folding frame (4) comprises a rotating piece (41), and four connecting rods (42) fixedly connected to the rotating piece (41); each rotating piece (41) comprises two hinged bases hinged to each other; two ends of each hinged base are provided with inserting connectors (43) used for being connected to the corresponding connecting rods (42); and the inserting connectors (43) at the two ends of at least one hinged base are arranged in a staggered mode.

2. The anti-pinch foldable trolley according to claim 1, wherein the inserting connectors (43) at the two ends of each hinged base are arranged in a staggered mode; two inserting connectors (43) located on the different hinged bases are arranged in a crossed mode; and four inserting connectors (43) are located in a same plane.

3. The anti-pinch foldable trolley according to claim 2, wherein the hinged bases are circular; two inserting connectors (43) are arranged on circular outer walls of the hinged bases in parallel in a staggered mode; the two circular hinged bases are hinged in a sleeved mode to form the rotating piece (41); and during storing, the four connecting rods (42) are in an H shape through the two hinged bases.

4. The anti-pinch foldable trolley according to claim 3, wherein the two hinged bases are a hinged base A (411) and a hinged base B (412) respectively and are both in a hollow circular shape; an annular shaft part (413) is arranged in the hinged base A (411); the hinged base B (412) is rotationally mounted on the annular shaft part (413); and the hinged base A (411) is provided with a rotating space for facilitating rotation of the hinged base B (412) in a circumferential direction of the annular shaft part (413).

5. The anti-pinch foldable trolley according to claim 4, wherein the hinged base A (411) comprises a first shell (414) and a second shell (415) connected to each other in a clamped mode, and the hinged base B (412) is rotationally mounted between the first shell (414) and the second shell (415).

6. The anti-pinch foldable trolley according to claim 2, wherein any one of two inserting connectors (43) located on a same side is provided with a first stop part (416), and the other one is provided with a second stop part (417); and after unfolding, the first stop part (416) and the second stop part (417) abut against each other for limiting.

7. The anti-pinch foldable trolley according to claim 1, wherein every two adjacent X-shaped folding frames (4) are hinged through a connecting structure (5); the connecting structure (5) is formed by hinging two hinged joints (51), and each hinged joint (51) is provided with a bent part; and in a storage state, hinge points of the hinged joints (51) are located on outer sides of the X-shaped folding frames (4).

8. The anti-pinch foldable trolley according to claim 1, wherein the bottom frame (1) comprises a center base (11) and four bottom rods (12); one end of each bottom rod is hinged to the center base (11), and the other end of each bottom rod (12) is hinged to the corresponding supporting column (3); and during storing, the center base (11) is lifted upwards, and the four bottom rods (12) drive the four supporting columns (3) to be folded towards the middle and drive the X-shaped folding frames (4) to be folded.

9. The anti-pinch foldable trolley according to claim 8, wherein each bottom rod (12) comprises a telescopic rod A (121) and a telescopic rod B (122) slidably connected to each other in a sleeved mode; a linkage rod (13) is hinged to the center base (11), and the linkage rod (13) is hinged to the telescopic rod A (121); and during storing, the center base (11) is lifted upwards, the linkage rod (13) compresses the telescopic rod A (121) and the telescopic rod B (122) to reduce a height of the center base (11) after folding.

10. The anti-pinch foldable trolley according to claim 8, wherein the bottom frame (1) further comprises supporting rods (14); one end of each supporting rod (14) is hinged to the center base (11), and the other end of each supporting rod is connected to a lower end of a center of the corresponding side frame through a connecting rope (15) to disperse a supporting force of the bottom frame (1).

11. The anti-pinch foldable trolley according to claim 1, wherein a handle assembly (6) is arranged at one end of the frame; the handle assembly (6) comprises a handle base (61), handle connecting rods (62) hinged to the handle base (61), and a handle (63) connected to the handle base (61) in a sleeved mode; and ends of the handle connecting rods (62) are hinged to the corresponding supporting columns (3).

12. The anti-pinch foldable trolley according to claim 1, wherein an upper end of one side of each X-shaped folding frame (4) is hinged to the corresponding supporting column (3), and a lower end of one side of each X-shaped folding frame is slidably hinged to the corresponding supporting column (3).
